(19) United States
(12) Patent Application Publication
(10) Pub. No.: US 2018/0040039 A1
(43) Pub. Date: Feb. 8, 2018

(54) Vehicle Component Partitioner

(71) Applicant: Audatex North America, Inc., Addison, TX (US)

(72) Inventors: Natasha Lee Wells, Tigard, OR (US); Phillip Bruce McDoniel, JR., Dallas, TX (US); Mark Daniel Lare, Middletown, DE (US); John Smith, JR., Escondido, CA (US); Michael Thomas Anderson, Bristol, RI (US); Jorge Ramon Ramirez, Chula Vista, CA (US); Joe Sullivan, Sandy, UT (US); Tatyana Melim, Rancho Santa Fe, CA (US)

(21) Appl. No.: 15/670,439

(22) Filed: Aug. 7, 2017

Related U.S. Application Data
(60) Provisional application No. 62/372,160, filed on Aug. 8, 2016.

(51) Int. Cl. G06Q 30/02; G06Q 40/08; G06Q 50/30; G06Q 10/00

(52) U.S. Cl. CPC G06Q 30/0283; G06Q 10/20; G06Q 40/08; G06Q 50/30

(57) ABSTRACT

In one embodiment, a method includes receiving input data related to a driver's vehicle and displaying a stock image of the driver's vehicle. The stock image includes multiple selectable body parts. The method further includes receiving a selection of a particular vehicle body part on the stock image that corresponds to a damaged body part of the driver's vehicle and displaying a partitioned image of the selected vehicle body part. The partitioned image includes multiple selectable regions. The method further includes receiving a selection of one or more particular regions of the partitioned image and determining a status of the damaged body part. The status indicates either to repair or to replace the damaged body part. The method further includes determining a line-item estimate for the damaged body part of the driver's vehicle and displaying one or more costs associated with the determined line-item estimate.

### CROSS-REFERENCE TO RELATED APPLICATION

This application claims the benefit of priority under 35 U.S.C. §119(e) of U.S. Provisional Application Ser. No. 62/372,160, entitled “Vehicle Component Partitioner,” filed Aug. 8, 2016, which is incorporated herein by reference in its entirety.

### TECHNICAL FIELD

This disclosure generally relates to vehicle components and more specifically to a vehicle component partitioner.

### BACKGROUND

Components of vehicles such as automobile body parts are often damaged and need to be repaired or replaced. For example, exterior panels of an automobile or a recreational vehicle (RV) may be damaged in a driving accident. As another example, the hood and roof of an automobile may be damaged by severe weather (e.g., hail, falling tree limbs, and the like). Typically, an appraiser is tasked with inspecting a damaged vehicle in connection with an insurance claim and providing an estimate to the driver and insurance company.

### SUMMARY OF PARTICULAR EMBODIMENTS

According to one embodiment, a system includes a touch-sensitive display, one or more processors, and memory communicatively coupled to the one or more processors. The memory includes instructions that are executable by the one or more processors. The one or more processors are operable when executing the instructions to receive input data related to a driver's automobile and, based on the input data, display on the touch-sensitive display a stock image of an automobile corresponding to the driver's automobile. The stock image includes a plurality of selectable automobile body parts. The one or more processors are further operable when executing the instructions to receive a selection of a particular automobile body part on the stock image that corresponds to a damaged body part of the driver's automobile and display, on the touch-sensitive display, a partitioned image of the selected automobile body part that corresponds to the damaged body part of the driver's automobile. The partitioned image includes a plurality of selectable regions. The one or more processors are further operable when executing the instructions to receive a selection of one or more particular regions of the partitioned image of the selected automobile body part, the selected one or more particular regions corresponding to damage on the damaged body part of the driver's automobile. The one or more processors are further operable when executing the instructions to determine, based at least on the input data and the selected one or more particular regions of the partitioned image of the selected automobile body part, a status of the damaged body part of the driver's automobile, the status indicating either to repair or to replace the damaged body part of the driver's automobile. The one or more processors are further operable when executing the instructions to determine, based on the determined status of the damaged body part of the driver's automobile, a line-item estimate for the damaged body part of the driver's automobile and display one or more costs associated with the determined line-item estimate on the touch-sensitive display.

According to another embodiment, a method includes receiving input data related to a driver's vehicle and, based on the input data, displaying a stock image of a vehicle corresponding to the driver's vehicle. The stock image includes a plurality of selectable vehicle body parts. The method further includes receiving a selection of a particular vehicle body part on the stock image that corresponds to a damaged body part of the driver's vehicle and displaying a partitioned image of the selected vehicle body part that corresponds to the damaged body part of the driver's vehicle. The partitioned image includes a plurality of selectable regions. The method further includes receiving a selection of one or more particular regions of the partitioned image of the selected vehicle body part, the selected one or more particular regions corresponding to damage on the damaged body part of the driver's vehicle. The method further includes determining, based at least on the input data and the selected one or more particular regions of the partitioned image of the selected vehicle body part, a status of the damaged body part of the driver's vehicle, the status indicating either to repair or to replace the damaged body part of the driver's vehicle. The method further includes determining, based at least on the determined status of the damaged body part of the driver's vehicle, a line-item estimate for the damaged body part of the driver's vehicle and displaying one or more costs associated with the determined line-item estimate.

According to another embodiment, one or more computer-readable non-transitory storage media embodies one or more units of software that are operable when executed to receive input data related to a driver's vehicle and, based on the input data, display a stock image of a vehicle corresponding to the driver's vehicle. The stock image includes a plurality of selectable vehicle body parts. The one or more units of software are further operable when executed to receive a selection of a particular vehicle body part on the stock image that corresponds to a damaged body part of the driver's vehicle and display a partitioned image of the selected vehicle body part that corresponds to the damaged body part of the driver's vehicle. The partitioned image includes a plurality of selectable regions. The one or more units of software are further operable when executed to receive a selection of one or more particular regions of the partitioned image of the selected vehicle body part, the selected one or more particular regions corresponding to damage on the damaged body part of the driver's vehicle. The one or more units of software are further operable when executed to determine, based at least on the input data and the selected one or more particular regions of the partitioned image of the selected vehicle body part, a status of the damaged body part of the driver's vehicle. The status indicates either to repair or to replace the damaged body part of the driver's vehicle. The one or more units of software are further operable when executed to determine, based at least on the determined status of the damaged body part of the driver's vehicle, a line-item estimate for the damaged body part of the driver's vehicle and display one or more costs associated with the determined line-item estimate.

Technical advantages of certain embodiments may include providing a system and method of partitioning components of a vehicle such as an automobile into two or more regions in order to more accurately and efficiently determine whether the components should be repaired or replaced. In addition, technical advantages of certain embodiments may include improving the efficiency of underlying computers and networks by reducing the amount of information communicated over the networks and reducing the time needed to provide estimates to repair or replace damaged vehicle components. Other technical advantages will be readily apparent to one skilled in the art from the following figures, descriptions, and claims. Moreover, while specific advantages have been enumerated above, various embodiments may include all, some, or none of the enumerated advantages.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a vehicle component partitioner.

FIGS. 2A-B illustrate an example personal computing device.

FIG. 3 illustrates an example software architecture for information and applications on a personal computing device.

FIG. 4 illustrates an example computer system.

FIGS. 5A-B illustrate an example mobile application associated with a vehicle component partitioner.

FIGS. 6A-B illustrate example partitioned components of a vehicle.

FIG. 7 illustrates an example method for providing an estimate based on partitioned vehicle components.

FIG. 8 illustrates another example method for providing an estimate based on partitioned vehicle components.

### DETAILED DESCRIPTION OF EXAMPLE EMBODIMENTS

Components of vehicles such as automobile body parts are often damaged and need to be repaired or replaced. For example, exterior panels (e.g., fenders, etc.) of an automobile or a recreational vehicle (RV) may be damaged in a driving accident. As another example, the hood and roof of an automobile may be damaged by severe weather (e.g., hail, falling tree limbs, and the like).

Typically, an appraiser is tasked with inspecting a damaged vehicle in connection with an insurance claim and providing an estimate to the driver and insurance company. Manually inspecting vehicles, however, is time consuming, costly, and inefficient. For example, after a severe weather event occurs in a community, it can take days, weeks, or even months before all damaged vehicles are inspected by approved appraisers. However, because drivers typically desire an estimate to repair or replace damaged vehicle components to be provided in a timely manner, such long response times can cause frustration and dissatisfaction for drivers whose automobiles were damaged by the weather event.

As another example, a driver whose automobile sustained minor damage in a driving accident is typically required to take the damaged automobile to an approved facility where the damage can be inspected by an approved appraiser. However, this may require the driver to take time off of work and/or drive an undesired distance to an approved location in order to have his automobile inspected. This, again, may cause frustration and dissatisfaction for the driver whose automobile was damaged in an accident.

The teachings of the disclosure recognize that it is desirable to provide estimates to repair or replace damaged vehicle components in a timely and user-friendly manner. The following describes systems and methods of automatically partitioning vehicle components for providing these and other desired features.

In general, embodiments of the disclosure provide an application (e.g., a mobile application or “app”) that allows drivers to submit information about a damaged vehicle and then view an automatically-generated estimate for repair or replacement of damaged components. For example, some embodiments provide a mobile app in which a driver can select a damaged body part from a stock photo that corresponds to his vehicle, select one or more regions of the damaged body part that corresponds to where the particular body part on their vehicle sustained damage, and then view an automatically-generated estimate or cost associated with repairing or replacing the damaged body part. As a result, drivers and insurance providers may be provided with detailed repair/replace estimates much quicker and easier than is typical today. Other benefits may include: improved cycle time for low severity claims from time of first notice of loss (FNOL) to first payment, improved overall customer service, a decreased number of appraisals being assigned to staff and allowing those resources to focus on higher severity claims, improved accuracy of appraisals while reducing the time needed for appraisers to review estimates, and decreased effort requirements for drivers to file claims.

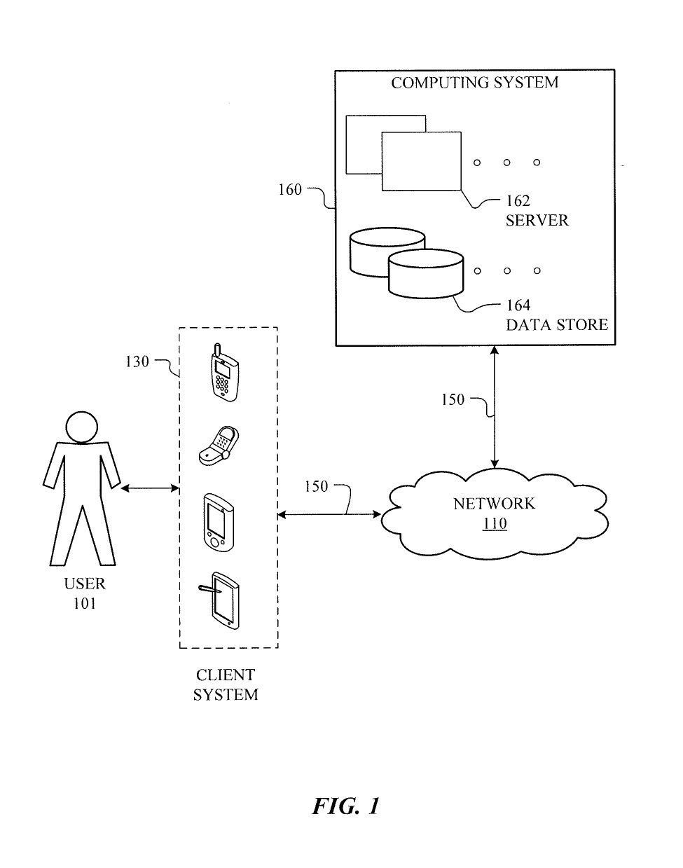

FIG. 1 illustrates an example network environment 100 associated with a vehicle component partitioner. Network environment 100 includes a user 101, a client system 130, a computing system 160, and a third-party system 170 connected to each other by a network 110. Although FIG. 1 illustrates a particular arrangement of client system 130, computing system 160, third-party system 170, and network 110, this disclosure contemplates any suitable arrangement of client system 130, computing system 160, third-party system 170, and network 110. As an example and not by way of limitation, two or more of client system 130, computing system 160, and third-party system 170 may be connected to each other directly, bypassing network 110. As another example, two or more of client system 130, computing system 160, and third-party system 170 may be physically or logically co-located with each other in whole or in part. Moreover, although FIG. 1 illustrates a particular number of client systems 130, computing systems 160, third-party systems 170, and networks 110, this disclosure contemplates any suitable number of client systems 130, computing systems 160, third-party systems 170, and networks 110. As an example and not by way of limitation, network environment 100 may include multiple client system 130, computing systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, computing system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system (e.g., computer system 400) such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, computing system 160 may be a network-addressable computing system. Computing system 160 may generate, store, receive, and send data. Computing system 160 may be accessed by the other components of network environment 100 either directly or via network 110. As an example and not by way of limitation, client system 130 may access computing system 160 using a web browser 132, or a native application associated with computing system 160 (e.g., a mobile application) either directly or via network 110. In particular embodiments, computing system 160 may include one or more servers 162. Each server 162 may be a unitary server or a distributed server spanning multiple computers or multiple datacenters. Servers 162 may be of various types, such as, for example and without limitation, web server, news server, mail server, message server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, computing system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a computing system 160, or a third-party system 170 to manage, retrieve, modify, add, or delete, the information stored in data store 164.

In particular embodiments, computing system 160 may be capable of linking a variety of entities. As an example and not by way of limitation, computing system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating computing system 160.

In particular embodiments, computing system 160 may include a variety of servers, sub-systems, programs, modules, logs, and data stores. In particular embodiments, computing system 160 may include one or more of the following: a web server, action logger, API-request server, notification controller, action log, third-party-content-object-exposure log, inference module, authorization/privacy server, search module, user-interface module, user-profile store, connection store, third-party content store, or location store. Computing system 160 may also include suitable components such as network interfaces, security mechanisms, load balancers, failover servers, management-and-network-operations consoles, other suitable components, or any suitable combination thereof. In particular embodiments, computing system 160 may include one or more user-profile stores for storing user profiles. A user profile may include, for example, biographic information, demographic information, behavioral information, social information, or other types of descriptive information. A web server may be used for linking computing system 160 to one or more client systems 130 or one or more third-party system 170 via network 110. The web server may include a mail server or other messaging functionality for receiving and routing messages between computing system 160 and one or more client systems 130. An API-request server may allow a third-party system 170 to access information from computing system 160 by calling one or more APIs. An action logger may be used to receive communications from a web server about a user's actions on or off computing system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of computing system 160. A privacy setting of a user determines how particular information associated with a user can be shared. The authorization server may allow users to opt in to or opt out of having their actions logged by computing system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users.

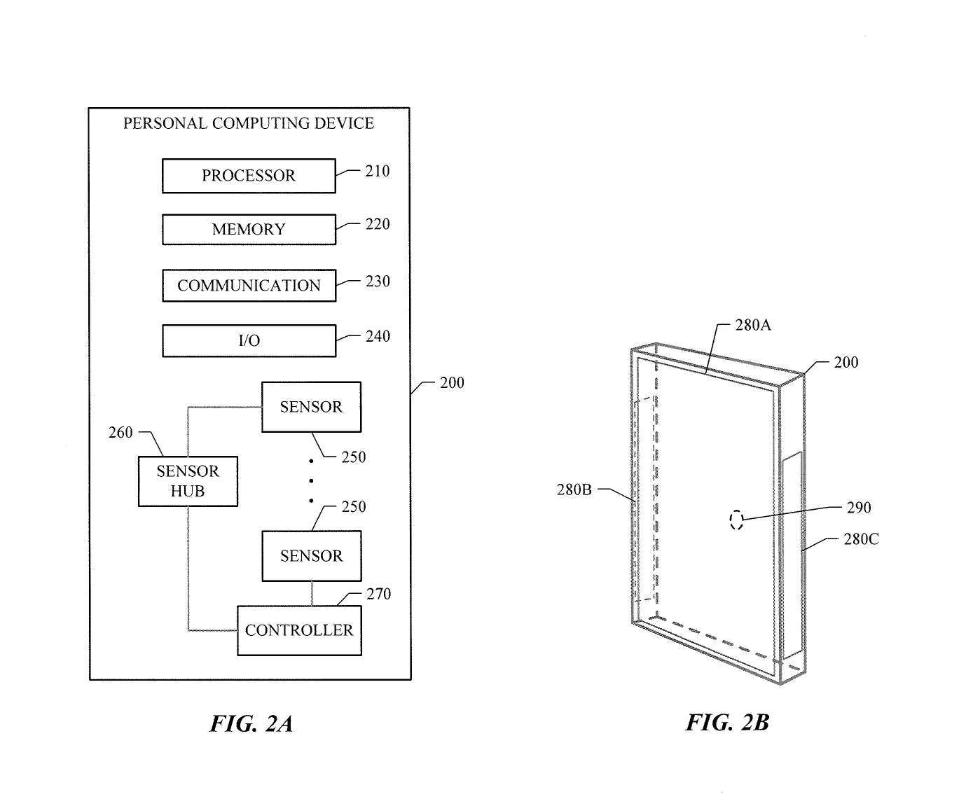

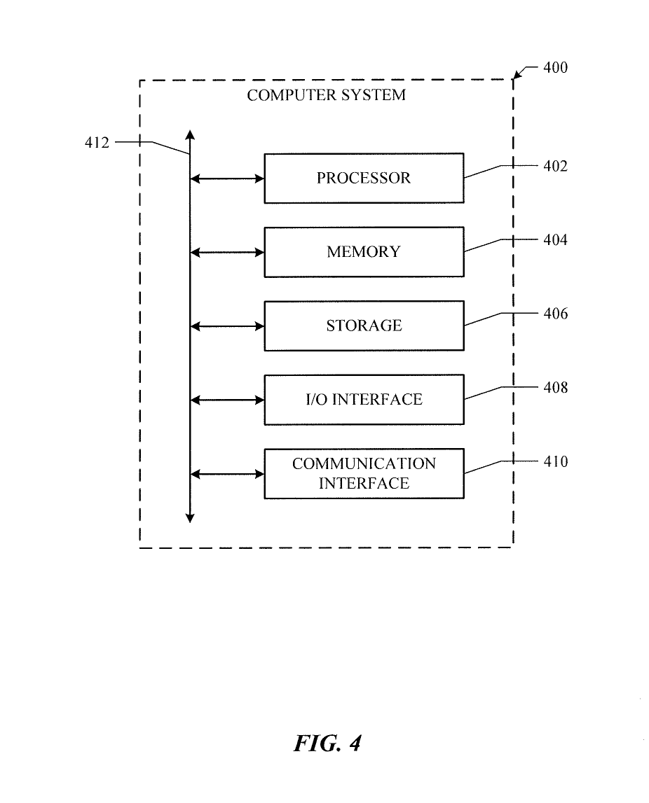

FIG. 2A illustrates an example personal computing device 200. In particular embodiments, personal computing device 200 includes a processor 210, a memory 220, a communication component 230 (e.g., antenna and communication interface for wireless communications), one or more input and/or output (I/O) components and/or interfaces 240, and one or more sensors 250. In particular embodiments, one or more I/O components and/or interfaces 240 may incorporate one or more sensors 250. In particular embodiments, personal computing device 200 may comprise a computer system or and element thereof as described in FIG. 4 and associated description.

In particular embodiments, personal computing device 200, such as a mobile device, may include various types of sensors 250, such as, for example and without limitation: touch sensors (disposed, for example, on a display of the device, the back of the device and/or one or more lateral edges of the device) for detecting a user touching the surface of the mobile electronic device (e.g., using one or more fingers); accelerometer for detecting whether the personal computing device 200 is moving and the speed of the movement; thermometer for measuring the temperature change near the personal computing device 200; proximity sensor for detecting the proximity of the personal computing device 200 to another object (e.g., a hand, desk, or other object); light sensor for measuring the ambient light around the personal computing device 200; imaging sensor (e.g., camera) for capturing digital still images and/or video of objects near the personal computing device 200 (e.g., scenes, people, bar codes, QR codes, etc.); location sensors (e.g., Global Positioning System (GPS)) for determining the location (e.g., in terms of latitude and longitude) of the mobile electronic device; sensors for detecting communication networks within close proximity (e.g., near field communication (NFC), Bluetooth, RFID, infrared); chemical sensors; biometric sensors for biometrics-based (e.g., fingerprint, palm vein pattern, hand geometry, iris/retina, DNA, face, voice, olfactory, sweat) authentication of user of personal computing device 200; etc. This disclosure contemplates that a mobile electronic device may include any applicable type of sensor. Sensors may provide various types of sensor data, which may be analyzed to determine the user's intention with respect to the mobile electronic device at a given time.

In particular embodiments, a sensors hub 260 may optionally be included in personal computing device 200. Sensors 250 may be connected to sensors hub 260, which may be a low power-consuming processor that controls sensors 250, manages power for sensors 250, processes sensor inputs, aggregates sensor data, and performs certain sensor functions. In addition, in particular embodiments, some types of sensors 250 may be connected to a controller 270. In this case, sensors hub 260 may be connected to controller 270, which in turn is connected to sensor 250. Alternatively, in particular embodiments, there may be a sensor monitor in place of sensors hub 260 for managing sensors 250.

In particular embodiments, in addition to the front side, personal computing device 200 may have one or more sensors for performing biometric identification. Such sensors may be positioned on any surface of personal computing device 200. In example embodiments, as the user's hand touches personal computing device 200 to grab hold of it, the touch sensors may capture the user's fingerprints or palm vein pattern. In example embodiments, while a user is viewing the screen of personal computing device 200, a camera may capture an image of the user's face to perform facial recognition. In example embodiments, while a user is viewing the screen of personal computing device 200, an infrared scanner may scan the user's iris and/or retina. In example embodiments, while a user is in contact or close proximity with personal computing device 200, chemical and/or olfactory sensors may capture relevant data about a user. In particular embodiments, upon detecting that there is a change in state with respect to the identity of the user utilizing personal computing device 200, either by itself or in combination with other types of sensor indications, personal computing device 200 may determine that it is being shared.

In particular embodiments, in addition to the front side, the personal computing device 200 may have touch sensors on the left and right sides. Optionally, the personal computing device 200 may also have touch sensors on the back, top, or bottom side. Thus, as the user's hand touches personal computing device 200 to grab hold of it, the touch sensors may detect the user's fingers or palm touching personal computing device 200. In particular embodiments, upon detecting that there is a change in state with respect to a user touching personal computing device 200, either by itself or in combination with other types of sensor indications, personal computing device 200 may determine that it is being shared.

In particular embodiments, personal computing device 200 may have an accelerometer in addition to or instead of the touch sensors on the left and right sides. Sensor data provided by the accelerometer may also be used to estimate whether a new user has picked up personal computing device 200 from a resting position, e.g., on a table or desk, display shelf, or from someone's hand or from within someone's bag. When the user picks up personal computing device 200 and brings it in front of the user's face, there may be a relatively sudden increase in the movement speed of personal computing device 200. This change in the device's movement speed may be detected based on the sensor data supplied by the accelerometer. In particular embodiments, upon detecting that there is a significant increase in the speed of the device's movement, either by itself or in combination with other types of sensor indications, personal computing device 200 may determine that it is being shared.

In particular embodiments, personal computing device 200 may have a Gyrometer in addition or instead of the touch sensors on the left and right sides. A Gyrometer, also known as a gyroscope, is a device for measuring the orientation along one or more axis. In particular embodiments, a Gyrometer may be used to measure the orientation of personal computing device 200. When personal computing device 200 is stored on a shelf or in the user's bag, it may stay mostly in one orientation. However, when the user grabs hold of personal computing device 200 and lifts it up and/or moves it closer to bring it in front of the user's face, there may be a relatively sudden change in the orientation of personal computing device 200. The orientation of personal computing device 200 may be detected and measured by the gyrometer. If the orientation of personal computing device 200 has changed significantly. In particular embodiments, upon detecting that there is a significant change in the orientation of personal computing device 200, either by itself or in combination with other types of sensor indications, personal computing device 200 may determine that it is being shared.

In particular embodiments, personal computing device 200 may have a light sensor. When personal computing device 200 is stored in a user's pocket or case, it is relatively dark around personal computing device 200. On the other hand, when the user brings personal computing device 200 out of his pocket, it may be relatively bright around personal computing device 200, especially during day time or in well-lit areas. The sensor data supplied by the light sensor may be analyzed to detect when a significant change in the ambient light level around personal computing device 200 occurs. In particular embodiments, upon detecting that there is a significant increase in the ambient light level around personal computing device 200, either by itself or in combination with other types of sensor indications, personal computing device 200 may determine that it is being shared.

In particular embodiments, personal computing device 200 may have a proximity sensor. The sensor data supplied by the proximity sensor may be analyzed to detect when personal computing device 200 is in close proximity to a specific object, such as the user's hand. For example, mobile device 200 may have an infrared LED (light-emitting diode) 290 (i.e., proximity sensor) placed on its back side. When the user holds such a mobile device in his hand, the palm of the user's hand may cover infrared LED 290. As a result, infrared LED 290 may detect when the user's hand is in close proximity to mobile device 200. In particular embodiments, upon detecting that personal computing device 200 is in close proximity to the user's hand, either by itself or in combination with other types of sensor indications, personal computing device 200 may determine that it is being shared.

A personal computing device 200 may have any number of sensors of various types, and these sensors may supply different types of sensor data. Different combinations of the individual types of sensor data may be used together to detect and estimate a user's current intention with respect to personal computing device 200 (e.g., whether the user really means to take personal computing device 200 out of his pocket and use it). Sometimes, using multiple types of sensor data in combination may yield a more accurate, and thus better, estimation of the user's intention with respect to personal computing device 200 at a given time than only using a single type of sensor data. Nevertheless, it is possible to estimate the user's intention using a single type of sensor data (e.g., touch-sensor data).

FIG. 2B illustrates the exterior of an example personal computing device 200. Personal computing device 200 has approximately six sides: front, back, top, bottom, left, and right. Touch sensors may be placed anywhere on any of the six sides of personal computing device 200. For example, in FIG. 2B, a touchscreen incorporating touch sensors 280A is placed on the front of personal computing device 200. The touchscreen may function as an input/output (I/O) component for personal computing device 200. In addition, touch sensors 280B and 280C are placed on the left and right sides of personal computing device 200, respectively. Touch sensors 280B and 280C may detect a user's hand touching the sides of personal computing device 200. In particular embodiments, touch sensors 280A, 280B, 280C may be implemented using resistive, capacitive, and/or inductive touch sensors. The electrodes of the touch sensors 280A, 280B, 280C may be arranged on a thin solid piece of material or a thin wire mesh. In the case of capacitive touch sensors, there may be two types of electrodes: transmitting and receiving. These electrodes may be connected to a controller (e.g., controller 270 illustrated in FIG. 2A), which may be a microchip designed to drive the transmitting electrodes with electrical pulses and measure the changes in capacitance from the receiving electrodes caused by a user's touches in order to detect the locations of the user touches.

Of course, personal computing device 200 is merely an example. In practice, a device may have any number of sides, and this disclosure contemplates devices with any number of sides. The touch sensors may be placed on any side of a device.

In particular embodiments, personal computing device 200 may have a proximity sensor 290 (e.g., an infrared LED) placed on its back side. Proximity sensor 290 may be able to supply sensor data for determining its proximity, and thus the proximity of personal computing device 200, to another object.

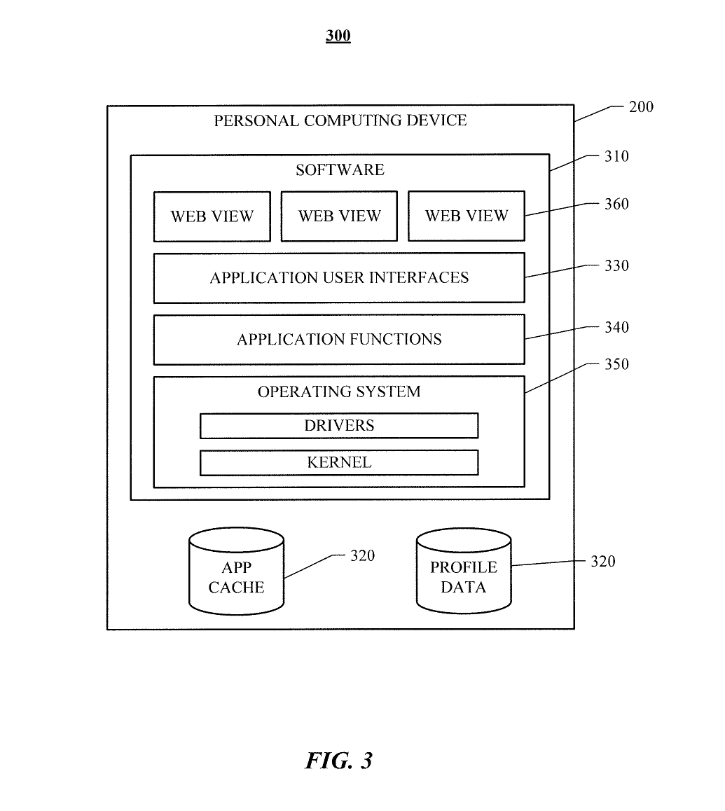

FIG. 3 illustrates an example software architecture 300 for information and applications on personal computing device 200. In particular embodiments, software architecture 300 includes software 310 and data store(s) 320. In particular embodiments, personal information may be stored in an application data cache 320 and/or a profile data store 320 and/or another data store 320. In particular embodiments, one or more software applications may be executed on personal computing device 200. In particular embodiments, they may be web-based applications hosted on servers. For example, a web-based application may be associated with a URI (Uniform Resource Identifier) or URL (Uniform Resource Locator). From personal computing device 200, a user may access the web-based application through its associated URI or URL (e.g., by using a web browser). Alternatively, in other embodiments, they may be native applications installed and residing on personal computing device 200. Thus, software 310 may also include any number of application user interfaces 330 and application functions 340. For example, one application (e.g., Google Maps®) may enable a device user to view a map, search for addresses and businesses, and get directions; a second application may enable the device user to read, send, and receive emails; a third application (e.g., a web browser) may enable the device user to browse and search the Internet; a fourth application may enable the device user to take photos or record videos using personal computing device 200; a fifth application may allow the device user to receive and initiate VoIP and/or cellular network calls, and so on. Each application has one or more specific functionalities, and the software (e.g., one or more software modules) implementing these functionalities may be included in application functions 340. Each application may also have a user interface that enables the device user to interact with the application, and the software implementing the application user interface may be included in application user interfaces 330. In particular embodiments, the functionalities of an application may be implemented using JavaScript®, Java®, C, or other suitable programming languages. In particular embodiments, the user interface of an application may be implemented using HyperText Markup Language (HTML), JavaScript®, Java®, or other suitable programming languages.

In particular embodiments, the user interface of an application may include any number of screens or displays. In particular embodiments, each screen or display of the user interface may be implemented as a web page. Thus, the device user may interact with the application through a series of screens or displays (i.e., a series of web pages). In particular embodiments, operating system 350 is Google's Android™ mobile technology platform. With Android®, there is a Java® package called “android.webkit”, which provides various tools for browsing the web. Among the “android.webkit” package, there is a Java class called “android.webkit.WebView”, which implements a View for displaying web pages. This class uses the WebKit rendering engine to display web pages and includes methods to navigate forward and backward through a history, zoom in, zoom out, perform text searches, and so on. In particular embodiments, an application user interface 330 may utilize Android's WebView API to display each web page of the user interface in a View implemented by the “android.webkit.WebView” class. Thus, in particular embodiments, software 310 may include any number of web views 360, each for displaying one or more web pages that implement the user interface of an application.

During the execution of an application, the device user may interact with the application through its user interface. For example, the user may provide inputs to the application in various displays (e.g., web pages). Outputs of the application may be presented to the user in various displays (e.g., web pages) as well. In particular embodiments, when the user provides an input to the application through a specific display (e.g., a specific web page), an event (e.g., an input event) may be generated by, for example, a web view 360 or application user interfaces 330. Each input event may be forwarded to application functions 340, or application functions 340 may listen for input events thus generated. When application functions 340 receive an input event, the appropriate software module in application functions 340 may be invoked to process the event. In addition, specific functionalities provided by operating system 350 and/or hardware (e.g., as described in FIGS. 3A-B) may also be invoked. For example, if the event is generated as a result of the user pushing a button to take a photo with personal computing device 200, a corresponding image processing module may be invoked to convert the raw image data into an image file (e.g., JPG or GIF) and store the image file in the storage 320 of personal computing device 200. As anther example, if the event is generated as a result of the user selecting an icon to compose an instant message, the corresponding short message service (SMS) module may be invoked to enable the user to compose and send the message.

In particular embodiments, when an output of the application is ready to be presented to the user, an event (e.g., an output event) may be generated by, for example, a software module in application functions 340 or operating system 350. Each output event may be forwarded to application user interfaces 330, or application user interfaces 330 may listen for output events thus generated. When application user interfaces 330 receive an output event, it may construct a web view 360 to display a web page representing or containing the output. For example, in response to the user selecting an icon to compose an instant message, an output may be constructed that includes a text field that allows the user to input the message. This output may be presented to the user as a web page and displayed to the user in a web view 360 so that the user may type into the text field the message to be sent.

The user interface of an application may be implemented using a suitable programming language (e.g., HTML, JavaScript®, or Java®). More specifically, in particular embodiments, each web page that implements a screen or display of the user interface may be implemented using a suitable programming language. In particular embodiments, when a web view 360 is constructed to display a web page (e.g., by application user interfaces 330 in response to an output event), the code implementing the web page is loaded into web view 360.

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

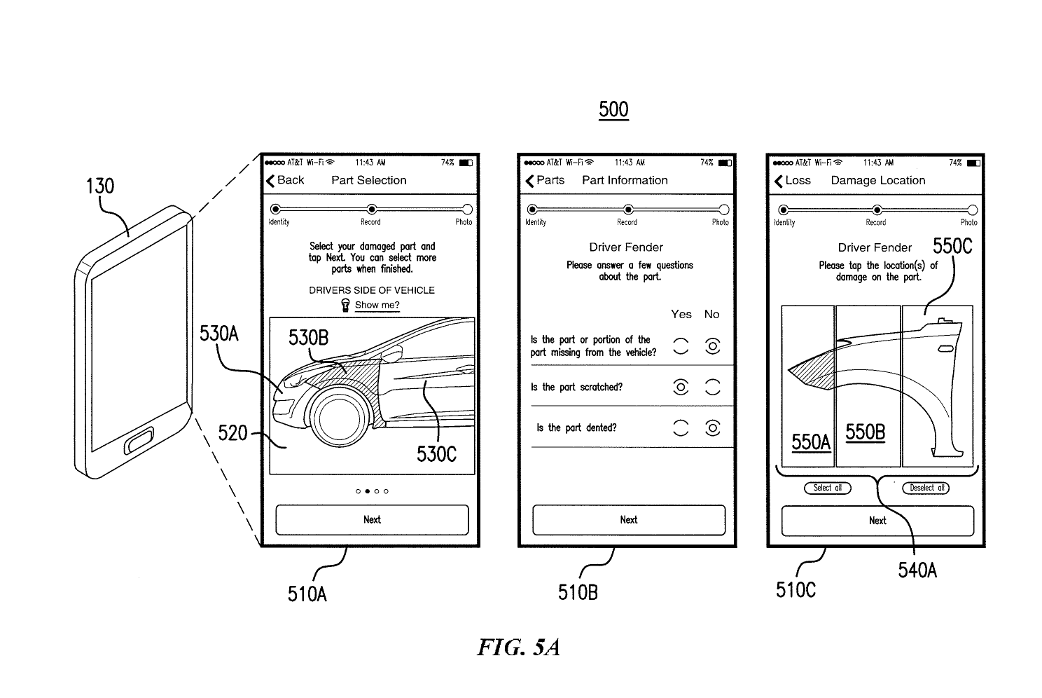

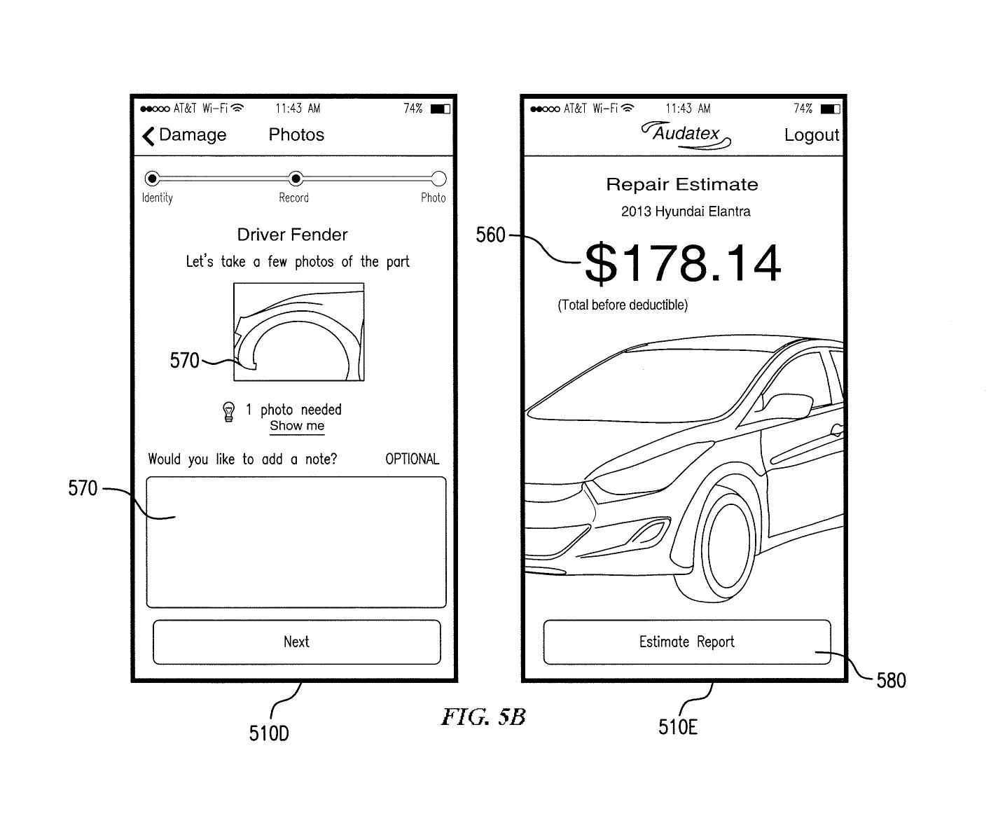

FIGS. 5A-B illustrate an example application 500 associated with a vehicle component partitioner. In some embodiments, application 500 includes, but is not limited to, interfaces 510 (e.g., interfaces 510A-E), as illustrated in FIGS. 5A-B. In some embodiments, application 500 includes other/additional interfaces. Application 500 may run on any client system 130 or personal computing device 200 such as a smartphone, a tablet computer, a laptop computer, or any other appropriate computing device. In some embodiments, application 500 is a mobile app. In other embodiments, application 500 is a web application.

In general, application 500 provides user 101 (e.g., a driver) with an easy and convenient way to provide details about damage to a vehicle and then view costs and/or a detailed estimate for repairing or replacing the damaged component(s) of their vehicle. For example, user 101 may be a driver who utilizes application 500 to provide input data (discussed in more detail below) about their damaged vehicle. Based on the input data, application 500 may then display pictures that allow user 101 to 1) select the damaged component (e.g., interface 510A), and 2) select one or more regions of the damaged component that correspond to the damage on their vehicle (e.g., interface 510C). Application 500 may then provide one or more costs (e.g., interface 510E) associated with repairing or replacing the damaged component(s) of their vehicle. More details about embodiments of application 500 and interfaces 510A-H are discussed below.

Application 500 may be utilized by any appropriate user 101. As discussed above, user 101 may be a driver who utilizes application 500 to provide input data about their damaged vehicle. In other embodiments, user 101 may be utilized to provide input data about a vehicle that is not owned by user 101. For example, application 500 may be utilized by insurance adjusters, body shop employees, auto dealers, or any other appropriate person/entity that desires to provide information about a damaged vehicle.

In some embodiments, application 500 may prompt user 101 to provide various input data related to the user's vehicle. For example, the input data provided by user 101 may include one or more of a Vehicle Identification Number (VIN), a year in which the user's vehicle was built (e.g., “2013”), a make of the user's vehicle (e.g., “Hyundai”), a model of the user's vehicle (e.g., “Elantra”), an amount of mileage of the user's vehicle (e.g., “12,345 miles”), the severity of the damage (e.g., minor, major, etc.), whether the vehicle is drivable, whether the airbags were deployed, and the like. In some embodiments, the user's VIN may be manually input into application 500 by user 101. Alternatively, user 101 may utilize a camera of personal computing device 200 to scan the vehicle's VIN (e.g., a barcode) in order to input the VIN into application 500.

In some embodiments, user 101 may not be required to manually input a VIN or other input data into application 500. Instead, application 500 may access stored profile information for user 101 (e.g., stored in memory 220, storage 406, etc.) in order to determine one or more vehicles associated with user 101. For example, application 500 may access profile data for user 101 and determine that user 101 owns a 2013 Hyundai Elantra. This profile information may then be used by application 500 to display subsequent interfaces 510 (e.g., interfaces 510A and 510C discussed below). In some embodiments, if profile information for user 101 indicates that user 101 owns more than one vehicle, application 500 may display a list of the vehicles owned by user 101 and prompt user 101 to select which vehicle was damaged.

Some embodiments of application 500 may include an interface 510A. In some embodiments, interface 510A displays a stock image 520. Stock image 520 may correspond to a damaged vehicle of user 101. For example, if the input data or profile data of user 101 indicates that the damaged vehicle of user 101 is a 2013 Hyundai Elantra, stock image 520 will be a stock image of a 2013 Hyundai Elantra. Stock image 520 may include one or more selectable body parts 530 (e.g., 530A-B). For example, stock image 520 may include a selectable front bumper 530A, a driver fender 530B, a driver door 530C, and the like. User 101 may select one or more body parts 530 (e.g., by using a finger, mouse, keyboard, stylus, etc.) in order to indicate to application 500 which body parts of user 101's vehicle were damaged.

In some embodiments, application 500 may highlight, in response to receiving a selection of a particular body part 530 on stock image 520 that corresponds to the damaged body part of the vehicle of user 101, the selected body part 530 on stock image 520. For example, in the embodiment of interface 510A illustrated in FIG. 5A, user 101 has selected driver fender 530B as corresponding to the damaged body part of their vehicle. Application 500 may respond by highlighting driver fender 530B as illustrated. The highlighting may include shading the selected particular body part 530 a different color from unselected body parts 530 on stock image 520, adding a symbol close to or on top of the selected body part 530 on stock image 520, outlining the selected body part 530 on stock image 520, or any other appropriate visual indication.

In some embodiments, application may display, either within interface 510A or on a separate interface 510, a confirmation message that seeks confirmation of the selected body part 530. In some embodiments, the confirmation message may include a textual description of the selected body part 530 and one or more selectable options for responding to the confirmation message. For example, if the user selects driver fender 530B, application 500 may display a confirmation message that reads “You selected the Driver Side Fender, is this correct?” and includes a “YES” and a “NO” selectable graphical element. User 101 may then select either “YES” or a “NO” to confirm their selection.

After receiving a selection of a particular body part 530 on stock image 520 in interface 510A that corresponds to the damaged body part of user 101's vehicle, application 500 may display interfaces 510B and 510C. In interface 510B, user 101 is presented with one or more questions regarding the body part 530 selected in interface 510A and one or more selectable answers for each question. These may include an option to indicate whether or not damaged body part 530 is missing from the vehicle, an option to indicate whether or not damaged body part 530 is scratched, an option to indicate whether or not damaged body part 530 is dented, and the like. For example, interface 510B may include “Is the part or portion of the part missing from the vehicle?”, “Is the part scratched?”, and “Is the part dented?”. The selectable answers may be “YES” or a “NO” for each question. This interface provides application 500 with additional input data about the damaged body part 530 of user 101's vehicle.

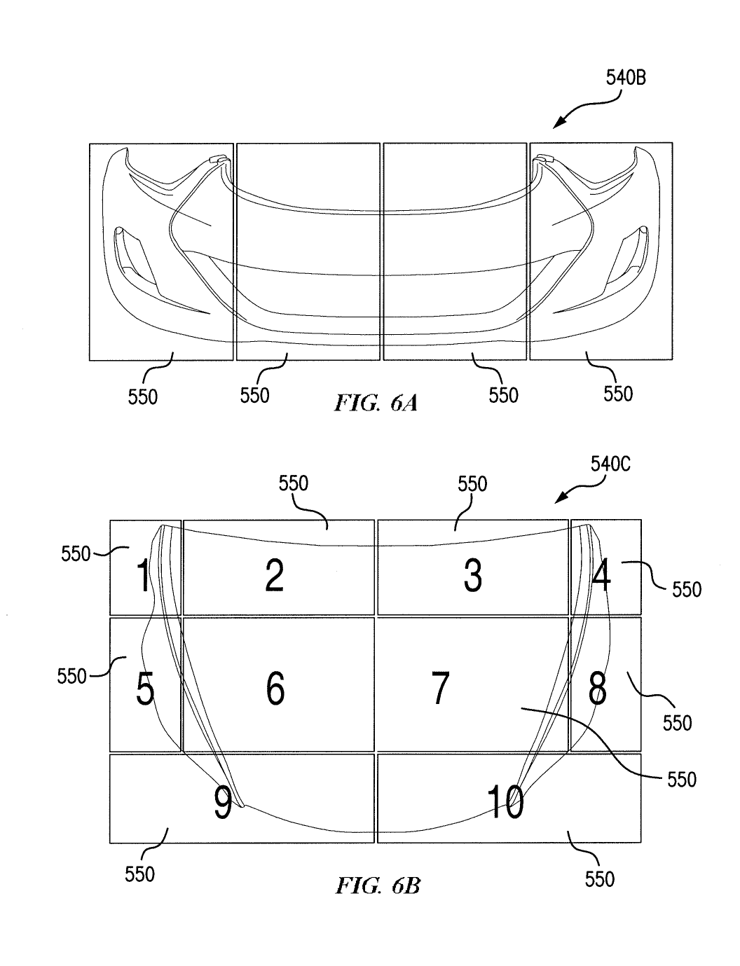

In interface 510C, which may be displayed after interface 510A or 510B, application 500 may display a partitioned image 540A of the selected body part 530 of interface 510A. For example, if user 101 selects driver fender 530B in interface 510A, interface 510C may display an enlarged and/or enhanced image of driver fender 530B as partitioned image 540A. Partitioned image 540A includes a plurality of selectable regions 550 (e.g., 550A-C) that divide partitioned image 540A into two or more regions. For example, as illustrated in interface 510C, partitioned image 540A of driver fender 530B may have three selectable regions 550: a left selectable region 550A, a middle selectable region 550B, and a right selectable region 550C. User 101 may select one or more selectable regions 550 (e.g., by using a finger, mouse, keyboard, stylus, etc.) in order to indicate to application 500 which regions of the selected body part of user 101's vehicle were damaged. For example, if the driver fender of user 101's vehicle was damaged only in the region closest to the driver's door, user 101 may select only selectable region 550C on partitioned image 540A. As another example, if user 101 had a collision on the front of their vehicle and the front two-thirds of their driver fender was damaged, user 101 may select selectable regions 550A and 550B. Any appropriate number of selectable regions 550 may be selected. In addition, the number of selectable regions 550 may vary depending on the body part and may include any appropriate number of regions. For example, FIGS. 6A-B illustrate, respectively, a partitioned image 540B of a front bumper (FIG. 6A) and a partitioned image 540C of a hood that each include different numbers of selectable regions 550.

In some embodiments, application 500 may highlight, in response to receiving the selection of the one or more selectable regions 550 on partitioned image 540, the selected one or more selectable regions 550 on partitioned image 540. For example, in the embodiment of interface 510C illustrated in FIG. 5A, user 101 has selected left selectable region 550A as corresponding to the location on their driver fender that sustained damage. Application 500 may respond by highlighting left selectable region 550A as illustrated. The highlighting may include shading the selected region(s) 550 a different color from unselected regions 550 on partitioned image 540, adding a symbol close to or on top of the selected region(s) 550 on partitioned image 540, outlining the selected region(s) 550 on partitioned image 540, or any other appropriate indication.

In some embodiments, the number, size, and location of selectable regions 550 on partitioned images 540 are determined based on data provided by insurance companies, appraisers, body shops, and the like. For example, historical data stored in one or more memory units (e.g., datastore 164) may be accessed in order to determine the size, number, and location of selectable regions 550. For example, the historical data, which may include images of damaged vehicle parts such as exterior panels, may be analyzed using any appropriate method including calculating probability of repair/replace status based on specific damage location and size on panel, probability of operations performed on adjacent panels based on the specific damage location and size on panel, probability of repair operations on a specified panel based on the specific damage location and size on said panel and confirmation of analysis results by subject matter experts to subdivide each part into regions 550 to correspond to areas in which an inspection (e.g., a visual inspection) indicated the presence of damage. In some embodiments, selectable regions 550 are equal size sections, while they may be different sizes in other embodiments. In some embodiments, for example, bumpers may have four selectable regions 550, fenders may have three selectable regions 550, rocker panels and quarter panel may have two selectable regions 550, roofs may have nine selectable regions 550, hoods may have ten selectable regions 550, doors may have twelve selectable regions 550, and deck lids may have eight selectable regions 550. In some embodiments, components such as headlamps, tail lamps, windshields, and mirrors may only have one selectable region 550.

In some embodiments, application 500 may transmit the input data and the selection of the one or more selectable regions 550 to another computing system for subsequent processing. For example, the input data and the selection of the one or more selectable regions 550 may be transmitted via one or more networks 110 to computing system 160 for processing (e.g., steps 720-750 of method 700 discussed below). In some embodiments, the processing may instead be performed directly by application 500 on personal computing device 200. This disclosure contemplates any appropriate computing system or combination of computing systems performing the disclosed steps and processes.

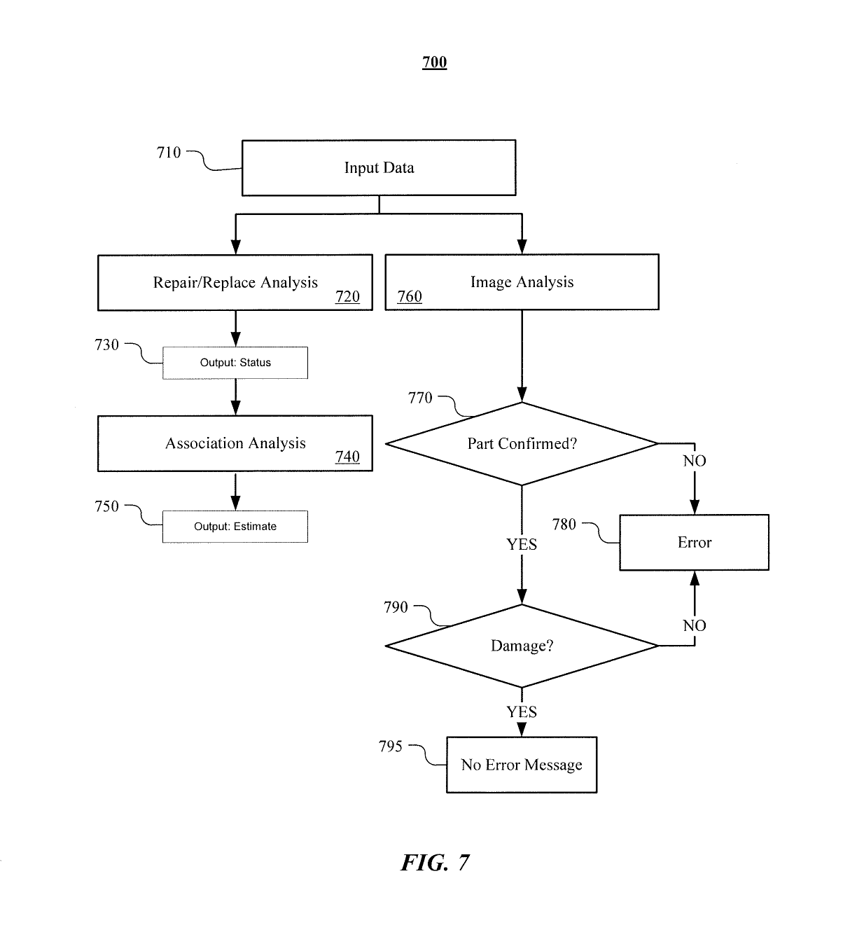

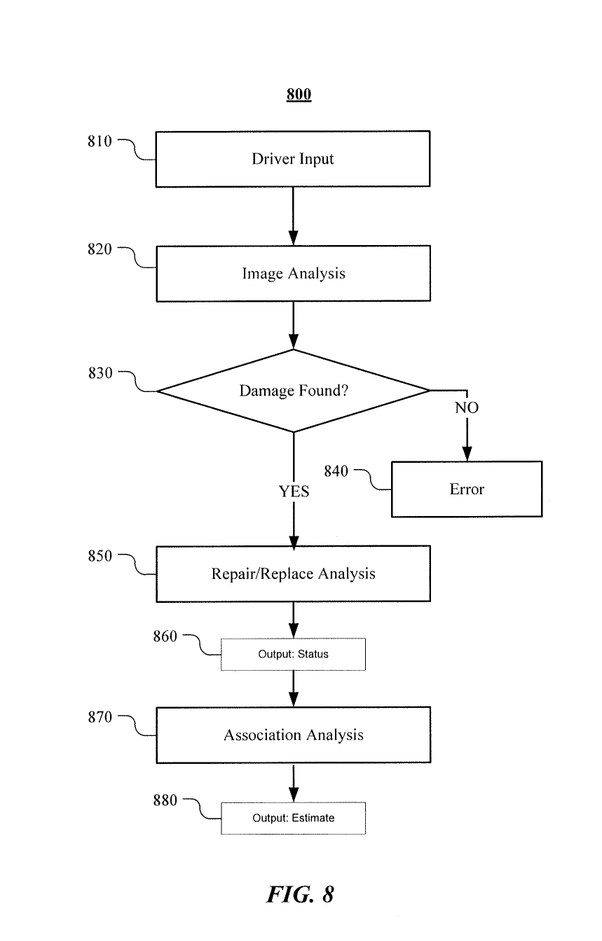

In some embodiments, application 500 may display interface 510D after interface 510C, or at any other appropriate time. In interface 510D, user 101 is instructed to provide a photograph 570 (or multiple photographs 570) of the damaged body part of user 101's vehicle. For example, user 101 may be instructed to take one or more photographs of the damaged body part using a camera of client system 130 or personal computing device 200. As another example, user 101 may be permitted to select an existing photo of the damaged body part that is stored on client system 130 or personal computing device 200. As yet another example, user 101 may utilize camera systems capable of taking multiple photos 570 of the damaged body part or creating multiple photos 570 from a scan of user 101's vehicle. In some embodiments, interface 510D may display the provided photograph 570 and a comment area 575 where user 101 may provide any comments about photograph 570. The one or more photographs 570 and any comments provided in comment area 575 may be stored locally (e.g., on client system 130 or personal computing device 200) and/or transmitted to another computing system (e.g., computing system 160). In some embodiments, photograph 570 (or multiple photographs 570) may be used to determine if the damage on the damaged body part of user 101's vehicle matches the selected body part 530 (e.g., from interface 510A) and/or the one or more selected regions 550 (e.g., from interface 510C). In some embodiments, the provided photograph(s) 570 may be used in addition to or in place of data provided by users 101 in interfaces 510A-510C (e.g., photograph(s) 570 may be analyzed to determine which body part 530 on user 101's vehicle is damaged and which region(s) 550 of the body part sustained the damage). Particular methods of using photograph(s) 570 for these processes are discussed in more detail below in reference to FIGS. 7-8.

In some embodiments, application 500 (or any other appropriate computing system such as computing system 160) may determine, based at least on the input data and the selected one or more selectable regions 550 of partitioned image 540, a status of the damaged body part user 101's vehicle. In some embodiments, the deteiniined status indicates either to repair or to replace the damaged body part of user 101's vehicle. Further details about this process are discussed below with respect to step 720 of FIG. 7 (i.e., “Repair/Replace Analysis”).

In some embodiments, application 500 (or any other appropriate computing system such as computing system 160) may determine, based on the determined status of the damaged body part of user 101's vehicle, a line-item estimate for the damaged body part of user 101's vehicle. For example, if it is determined that the body part is to be replaced, the line-item estimate may include a list of parts needed to replace the damaged body part and a cost associated with each part (e.g., component cost, labor cost, etc.). As another example, if it is determined that the body part is to be repaired, the line-item estimate may include a list of labor items needed to repair the damaged part and a cost associated with each labor item. Further details about this process are discussed below with respect to step 740 of FIG. 7 (i.e., “Association Analysis”).

In some embodiments, application 500 may display interface 510E after interface 510D, or at any other appropriate time. Interface 510E may display one or more costs 560 associated with the determined line-item estimate. Cost 560 may be a total price to repair the damage to user 101's vehicle, a total price to replace the damaged body part, a total price (before deductible) to repair the damage to user 101's vehicle, a total price (before deductible) to replace the damaged body part, a cost for parts to repair the damage to user 101's vehicle, a cost for labor to repair the damage to user 101's vehicle, a cost for paint to repair the damage to user 101's vehicle, or any other appropriate cost associated with addressing damage to user 101's vehicle. In some embodiments, interface 510E may include a selectable option 580 to display the actual line-item estimate.

FIG. 7 illustrates an example method 700 for providing an estimate based on partitioned vehicle components. In some embodiments, method 700 begins at step 710 where input data is provided. In some embodiments, the input data is provided by a driver whose vehicle was damaged in an accident, a weather event, and the like. The input data of step 710 may be any input data described above such as a VIN of the driver's vehicle, a particular damaged component of the driver's vehicle (e.g., body part 530), one or more regions of the body part that were damaged (e.g., selectable regions 550), photograph 570, and the like. In some embodiments, the input data of step 710 is provided via a mobile app such as application 500 described above.

At step 720, method 700 performs a repair/replace analysis using the input data of step 710. In general, this step determines if a body part of the driver's vehicle may be repaired or if it is damaged severely enough that repair is not financially or operationally viable to undertake and therefore should be replaced. The output of this step, shown as step 730 in method 700, is a status of the damaged component of the driver's vehicle (i.e., either “repair” or “replace”.) In some embodiments, this step focuses on key exterior panels that are visible to a consumer such as the bumpers, fenders, headlamps, fog lamps, tail lamps, windshields, doors, mirrors, rocker panels, quarter panels, hood, deck lid, and roof. [78] In some embodiments, step 720 of method 700 may utilize a model generated from a visual inspection and labeling of a historical sample of images of damaged and undamaged body parts. For example, a “bag of visual words” or a “bag of features” analysis using software such as MATLAB may be used. In some embodiments, sample images may identify the type of damage (e.g., scuff, scratch, dent, partially detached, fully detached, missing, small or large tear, holed or crumpled) and the location of the damage. Location of the damage may vary by each body part, and each body part may be subdivided into regions (e.g., selectable regions 550 described above). The visual inspection and assignment may be combined with consumer self-reported data that details information such as the accident type, point-of-impact, vehicle value, and the actual exterior panel disposition if it was repaired or replaced. Based on the combined set of data, a probabilistic model may be constructed to determine the probability of an exterior panel needing to be replaced. The modeling process may include data preparation as described above, variable transformation to confirm to algorithmic assumptions, handling of missing and outlier values, and the application of a stepwise logistic model that assigns a probability of replace score to an exterior panel. Model accuracy may be substantiated through validating scoring results against a hold-out dataset.

In some embodiments, step 720 may include a predictive model and/or a rules engine to determine the repair/replace status of vehicle body parts. For example, the rules engine may accept various inputs (e.g., which regions 550 were selected, which body part was selected, the type of damage, the total number of regions 550 selected, etc.) and then use the inputs with various predetermined rules in order to determine part status. As one example, a rule may be to repair a bumper if two or fewer regions 550 were damaged. As a second example, another rule may be to replace any part in which all regions 550 were damaged. As a third example, another rule may be to repair a hood if the damage type is a scratch and less than half of regions 550 were damaged. In some embodiments, the severity of the damage, which may be used to determine whether to repair or to replace, may be based on which regions 550 contain damage (as indicated by user 101 in interface 510C or as determined from analyzing photograph 570 using methods and systems described herein). For example, if it is determined that right selectable region 550C sustained dent damage, and it is known that this region is particularly difficult/costly to repair, it may be determined to replace the part instead of repairing it. Other variables that may be used to determine whether to repair or replace a part may include vehicle age, mileage, total number of damaged parts grouped by claim number (this could indicated duel impacts and severity of hit), point of impact, make, model, style, model year, loss type, and the like. Any appropriate number and type of variables and rules may be used.

At step 740 of method 700, an association analysis is performed. In general, this step determines associated actions that must be performed with respect to the damaged component of the driver's vehicle. For example, if step 720 assigns a status of “repair” to a dented fender (e.g., driver fender 530B), step 740 may determine that the additional actions of priming and painting must also be performed along with any actions to remove the dent. As another example, if step 720 assigns a status of “replace” to a dented fender (e.g., 530B), step 740 may determine that the additional action of adding a new emblem must also be performed along with the replacement of the fender. The associated actions may be determined by analyzing a database of known actions. For example, the database may link two repair items indicating that an action must be performed if another action is performed. The output of step 740 is an estimate in step 750. The estimate may be a line-item estimate discussed further below, or it may be any appropriate cost associated with repairing or replacing the damaged component of the driver's vehicle (e.g., cost 560 discussed above).

In some embodiments, the line-item estimate created in step 750 may be created using any appropriate method. In some embodiments, a database of parts and their associated costs may be accessed in order to create the line-item estimate. For example, once components to repair or replace have been identified in steps 720 and 740, those components and their associated costs (e.g., component costs, labor times, labor costs, etc.) can be accessed in the database and compiled into the line-item estimate. A cost such as cost 560 may then be calculated using the line-item estimate.

In some embodiments, selectable regions 550, along with other pertinent information such as body part type, may be utilized in step 740 in generating the line-item estimate that is output in step 750. For example, consider a scenario where driver fender 530B in FIG. 5A is assigned a status of “repair” and each selectable region 550A-C is assigned two total labor hours for repair. Since user 101 selected only selectable region 550A in interface 510C, the line-item estimate will include two labor hours to repair driver fender 530B. As another example, if user 101 selects two selectable regions 550, the line-item estimate will include four labor hours to repair driver fender 530B.

In embodiments where application 500 is being used by a driver or anyone who is not an appraiser, step 740 may create a preliminary estimate that is sent to a compliance engine, and a preliminary line item estimate may be provided to an appraiser for final review. In the compliance engine, state regulations for appraiser review and license documentation may be applied where applicable. In states where no regulations apply, insurers at their option may deliver a fully automated estimate back to the consumer (e.g., via PDF). During appraiser review, the appraiser may confirm the preliminary estimate is in compliance, is reasonably accurate, and will have the ability to make changes if needed. Once the appraiser accepts the preliminary estimate or makes changes, the appraiser may complete and lock the estimate. At that point, a PDF copy may be returned to the driver electronically. Once the driver receives the estimate, they may have several options based on the insurer's criteria such as: request a call back from the insurer, request payment directly, schedule an appointment with a repair facility, request a list of local shops to consider for repairs, and the like. In some embodiments, insurer specific rules (e.g., rules of a specific insurance company) may be applied to these processes.

In some embodiments, method 700 may include step 760 in which image analysis is performed. In general, step 760 may be performed in order to confirm the component selected by the driver (e.g., the body part selected in interface 510A) and/or whether or not the selected body part is indeed damaged. For example, photograph 570 taken using interface 510D may be analyzed to confirm that it is a photograph of the component selected in interface 510A (e.g., a driver fender). As another example, photograph 570 may be analyzed to determine a probability that the photographed component is damaged. Methods of analyzing photograph 570 are discussed below.

In some embodiments, a “bag of visual words” or a “bag of features” algorithm in software such as MATLAB may be used to analyze photograph 570 in step 760. For example, a training set of photographs may first be input into such an algorithm in order to train and instruct the algorithm on damaged and undamaged body parts. As a specific example, multiple photos of both damaged and undamaged driver fenders on a 2013 Hyundai Elantras may be input as the training set of photographs. Once the algorithm is properly trained, photograph 570 may then be input into the algorithm and compared to the training set of photographs. The algorithm may then output a confidence score regarding whether photograph 570 matches the body part in the training set and/or a confidence score regarding whether or not the body part in photograph 570 is damaged.

In step 770 of method 700, the confidence score determined in step 760 regarding whether photograph 570 matches the body part in the training set is analyzed. If the determined confidence score is above a predetermined value, (i.e., the body part in photograph 570 is determined to match the selected body part in interface 510A), method 700 proceeds to step 790. Otherwise, method 700 proceeds to step 780 where an error flag may be created for an appraiser to carefully review the claim.

In step 790 of method 700, the confidence score determined in step 760 regarding whether or not the body part in photograph 570 has any damaged is analyzed. If the determined confidence score is above a predetermined value, (i.e., the body part in photograph 570 is determined to have damage), method 700 proceeds to step 795 where no error message is displayed Otherwise, method 700 proceeds to step 780 where an error flag may be created for an appraiser to carefully review the claim.

In some embodiments, photograph 570 (or multiple photographs 570) may be analyzed in step 760 in order to determine the nature (e.g., severity) and/or location of damage on the body part. For example, systems and methods of scanning a portion or all of a vehicle may be used in order to determine how much damage the body part sustained and the exact location in which the damage occurred (e.g., camera systems may scan the damage and then one or more photographs 570 created from the scan may be provided to steps 720, 740, 770, and or 790 for processing). Such methods may be used to verify the information entered by user 101 in interface 510C (e.g., the selection of one or more selectable regions 550).

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for providing an estimate based on partitioned vehicle components including the particular steps of the method of FIG. 7, this disclosure contemplates any suitable method for providing an estimate based on partitioned vehicle components including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

FIG. 8 illustrates an example method 800 for providing an estimate based on partitioned vehicle components. Method 800 is similar to method 700, except that image analysis step 820 is used to gather information on the driver's vehicle in place of input data from the driver (e.g. instead of data gathered in interfaces 510A and 510C). For example, input data of step 810 may primarily include a photograph of the damaged body part (e.g. photograph 570). The photograph may then be analyzed in step 820 using the systems and methods of step 760 of FIG. 7 in order to determine the severity and location of the damage. If any damage is found in step 830, method 800 proceeds to step 850, which is similar to or identical to step 720 of FIG. 7. If no damage is found in step 830, an error flag may be set in step 840. The remainder of the steps of method 800 (i.e, steps 860, 870, and 880) are similar to or identical to corresponding steps of method 700 (i.e., steps 730, 740, and 750).

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for providing an estimate based on partitioned vehicle components including the particular steps of the method of FIG. 8, this disclosure contemplates any suitable method for providing an estimate based on partitioned vehicle components including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “vehicle” encompasses any appropriate means of transportation that user 101 may own and/or use. For example, “vehicle” includes, but is not limited to, any ground-based vehicle such as an automobile, a motorcycle, an RV, an all terrain vehicle (ATV), a golf cart, and the like. “Vehicle” also includes, but is not limited to, any water-based vehicle such as a boat, a jet ski, and the like. “Vehicle” also includes, but is not limited to, any air-based vehicle such as an airplane, a helicopter, and the like.

Herein, reference to a computing system or device may include any appropriate computer such as client system 130, computing system 160, personal computing device 200, computer system 400, server 162, or any combination of any of these or similar systems and devices.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a claim.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A system comprising:
a touch-sensitive display;
one or more processors; and
a memory communicatively coupled to the one or more processors, the memory comprising instructions executable by the one or more processors, the one or more processors being operable when executing the instructions to:
receive input data related to a driver's automobile;
based on the input data, display on the touch-sensitive display a stock image of an automobile corresponding to the driver's automobile, the stock image comprising a plurality of selectable automobile body parts;
receive a selection of a particular automobile body part on the stock image that corresponds to a damaged body part of the driver's automobile;
display, on the touch-sensitive display, a partitioned image of the selected automobile body part that corresponds to the damaged body part of the driver's automobile, the partitioned image comprising a plurality of selectable regions;
receive a selection of one or more particular regions of the partitioned image of the selected automobile body part, the selected one or more particular regions corresponding to damage on the damaged body part of the driver's automobile;
determine, based at least on the input data and the selected one or more particular regions of the partitioned image of the selected automobile body part, a status of the damaged body part of the driver's automobile, the status indicating either to repair or to replace the damaged body part of the driver's automobile;
determine, based on the determined status of the damaged body part of the driver's automobile, a line-item estimate for the damaged body part of the driver's automobile; and
display one or more costs associated with the determined line-item estimate on the touch-sensitive display.

2. The system of claim 1, wherein the one or more processors are further operable when executing the instructions to:
display, on the touch-sensitive display, instructions to capture an image of the damaged body part of the driver's automobile using a camera; and
determine, using the captured image of the damaged body part of the driver's automobile, if the damage on the damaged body part of the driver's automobile matches the selection of the one or more particular regions of the partitioned image of the selected automobile body part.

3. The system of claim 1, wherein the input data comprises one or more of:
a Vehicle Identification Number (VIN);
a year in which the driver's automobile was built;
a make of the driver's automobile;
a model of the driver's automobile; and
an amount of mileage of the driver's automobile.

4. The system of claim 1, wherein the one or more processors, in response to receiving the selection of the particular automobile body part on the stock image that corresponds to the damaged body part of the driver's automobile, are further operable when executing the instructions to:
highlight the selected particular automobile body part on the stock image that is displayed on the touch-sensitive display; and
display, on the touch-sensitive display, a confirmation message seeking confirmation of the selected automobile body part, the confirmation message comprising a textual description of the selected automobile body part and one or more selectable options for responding to the confirmation message;
wherein highlighting the selected particular automobile body part on the stock image comprises one or more of:
shading the selected particular automobile body part a different color from unselected body parts on the stock image;
adding a symbol proximate to or on top of the selected particular automobile body part on the stock image; and
outlining the selected particular automobile body part on the stock image.

5. The system of claim 1, wherein the one or more processors, in response to receiving the selection of the one or more particular regions of the partitioned image of the selected automobile body part, are further operable when executing the instructions to:
highlight the selected one or more particular regions on the partitioned image of the selected automobile body part that is displayed on the touch-sensitive display;
wherein highlighting the selected one or more particular regions on the partitioned image of the selected automobile body part comprises one or more of:
shading the selected one or more particular regions a different color from unselected regions on the partitioned image;
adding a symbol proximate to or on top of the selected one or more particular regions on the partitioned image; and
outlining the selected one or more particular regions on the partitioned image.

6. The system of claim 1, wherein the one or more processors are further operable when executing the instructions to display, on the touch-sensitive display, a plurality of selectable options seeking additional information related to the damaged body part, the plurality of selectable options comprising:
an option to indicate whether or not the damaged body part is missing from the driver's automobile;
an option to indicate whether or not the damaged body part is scratched; and
an option to indicate whether or not the damaged body part is dented.

7. The system of claim 1, wherein:
the one or more processors are further operable to receive an indication of a type of damage of the damaged body part of the driver's automobile; and
determining the status of the damaged body part of the driver's automobile comprises utilizing a predictive model to determine whether to repair or to replace the damaged body part of the driver's automobile, the predictive model utilizing one or more inputs to evaluate a plurality of rules, the inputs comprising one or more of:
which particular automobile body part was selected;
which particular regions were selected;
a total number of regions selected; and
the type of damage.

8. The system of claim 1, wherein determining the line-item estimate for the damaged body part of the driver's automobile comprises accessing a database of body parts, the database indicating, for each particular body part, at least one or more of:
an amount of time to replace the particular body part;
a cost associated with replacing the particular body part; and
one or more associated body parts.

9. The system of claim 1, wherein the displayed one or more costs associated with the determined line-item estimate comprise one or more of:
a total price to repair the damage to the driver's automobile;
a total price to replace the damaged body part;
a total price, before deductible, to repair the damage to the driver's automobile;
a total price, before deductible, to replace the damaged body part;
a cost for parts to repair the damage to the driver's automobile;
a cost for labor to repair the damage to the driver's automobile; and
a cost for paint and other materials to repair the damage to the driver's automobile.

10. The system of claim 1, wherein the one or more processors are further operable when executing the instructions to display, on the touch-sensitive display, a selectable option to display the line-item estimate.

11. A method comprising:
by one or more computing systems, receiving input data related to a driver's vehicle;
by the one or more computing systems based on the input data, displaying a stock image of a vehicle corresponding to the driver's vehicle, the stock image comprising a plurality of selectable vehicle body parts;
by the one or more computing systems, receiving a selection of a particular vehicle body part on the stock image that corresponds to a damaged body part of the driver's vehicle;
by the one or more computing systems, displaying a partitioned image of the selected vehicle body part that corresponds to the damaged body part of the driver's vehicle, the partitioned image comprising a plurality of selectable regions;
by the one or more computing systems, receiving a selection of one or more particular regions of the partitioned image of the selected vehicle body part, the selected one or more particular regions corresponding to damage on the damaged body part of the driver's vehicle;
by the one or more computing systems, determining, based at least on the input data and the selected one or more particular regions of the partitioned image of the selected vehicle body part, a status of the damaged body part of the driver's vehicle, the status indicating either to repair or to replace the damaged body part of the driver's vehicle;
by the one or more computing systems, determining, based at least on the determined status of the damaged body part of the driver's vehicle, a line-item estimate for the damaged body part of the driver's vehicle; and
by the one or more computing systems, displaying one or more costs associated with the determined line-item estimate.

12. The method of claim 11, further comprising:
by the one or more computing systems, displaying instructions to capture an image of the damaged body part of the driver's vehicle using a camera; and
by the one or more computing systems, determining, using the captured image of the damaged body part of the driver's vehicle, if the damage on the damaged body part of the driver's vehicle matches the selection of the one or more particular regions of the partitioned image of the selected vehicle body part.

13. The method of claim 11, wherein the input data comprises one or more of:
a Vehicle Identification Number (VIN);
a year in which the driver's automobile was built;
a make of the driver's automobile;
a model of the driver's automobile; and
an amount of mileage of the driver's automobile.

14. The method of claim 11, further comprising, in response to receiving the selection of the particular vehicle body part on the stock image that corresponds to the damaged body part of the driver's vehicle:
by the one or more computing systems, highlighting the selected particular vehicle body part on the stock image; and
by the one or more computing systems, displaying a confirmation message seeking confirmation of the selected vehicle body part, the confirmation message comprising a textual description of the selected vehicle body part and one or more selectable options for responding to the confirmation message;
wherein highlighting the selected particular vehicle body part on the stock image comprises one or more of:
shading the selected particular vehicle body part a different color from unselected body parts on the stock image;
adding a symbol proximate to or on top of the selected particular vehicle body part on the stock image; and
outlining the selected vehicle automobile body part on the stock image.

15. The method of claim 11, further comprising, in response to receiving the selection of the one or more particular regions of the partitioned image of the selected vehicle body part:
by the one or more computing systems, highlighting the selected one or more particular regions on the partitioned image of the selected vehicle body part;
wherein highlighting the selected one or more particular regions on the partitioned image of the selected vehicle body part comprises one or more of:
shading the selected one or more particular regions a different color from unselected regions on the partitioned image;
adding a symbol proximate to or on top of the selected one or more particular regions on the partitioned image; and
outlining the selected one or more particular regions on the partitioned image.

16. One or more computer-readable non-transitory storage media embodying one or more units of software that are operable when executed to:
receive input data related to a driver's vehicle;
based on the input data, display a stock image of a vehicle corresponding to the driver's vehicle, the stock image comprising a plurality of selectable vehicle body parts;
receive a selection of a particular vehicle body part on the stock image that corresponds to a damaged body part of the driver's vehicle;
display a partitioned image of the selected vehicle body part that corresponds to the damaged body part of the driver's vehicle, the partitioned image comprising a plurality of selectable regions;
receive a selection of one or more particular regions of the partitioned image of the selected vehicle body part, the selected one or more particular regions corresponding to damage on the damaged body part of the driver's vehicle;
determine, based at least on the input data and the selected one or more particular regions of the partitioned image of the selected vehicle body part, a status of the damaged body part of the driver's vehicle, the status indicating either to repair or to replace the damaged body part of the driver's vehicle;
determine, based at least on the determined status of the damaged body part of the driver's vehicle, a line-item estimate for the damaged body part of the driver's vehicle; and
display one or more costs associated with the determined line-item estimate.

17. The media of claim 16, wherein the one or more units of software are further operable when executed to:
display instructions to capture an image of the damaged body part of the driver's vehicle using a camera; and
determine, using the captured image of the damaged body part of the driver's vehicle, if the damage on the damaged body part of the driver's vehicle matches the selection of the one or more particular regions of the partitioned image of the selected vehicle body part.

18. The media of claim 16, wherein the input data comprises one or more of:
a Vehicle Identification Number (VIN);
a year in which the driver's automobile was built;
a make of the driver's automobile;
a model of the driver's automobile; and
an amount of mileage of the driver's automobile.

19. The media of claim 16, wherein the driver's vehicle comprises:
an automobile;
a motorcycle;
a recreational vehicle (RV);
an all terrain vehicle (ATV);
a golf cart;
a boat;
a jet ski;
an airplane; or
a helicopter.

20. The media of claim 16, wherein the displayed one or more costs associated with the determined line-item estimate comprise one or more of:
a total price to repair the damage to the driver's vehicle;
a total price to replace the damaged body part;
a total price, before deductible, to repair the damage to the driver's vehicle;
a total price, before deductible, to replace the damaged body part;
a cost for parts to repair the damage to the driver's vehicle;
a cost for labor to repair the damage to the driver's vehicle; and
a cost for paint and other materials to repair the damage to the driver's vehicle.
